(19) United States
(12) Patent Application Publication
(10) Pub. No.: US 2012/0091066 A1
(43) Pub. Date: Apr. 19, 2012

(54) Capturing and Storing Excess Co2 by Seeding Melt Water Lakes from Glacial Masses with Metal Hydroxides

(76) Inventor: Kenneth D. Murray, Huntington, VT (US)

(21) Appl. No.: 13/262,438

(22) PCT Filed: Apr. 27, 2009
(86) PCT No.: PCT/US2009/041806

§ 371 Date: Dec. 15, 2011

Related U.S. Application Data
(60) Provisional application No. 61/164,624, filed on Mar. 30, 2009.

(51) Int. Cl. C02F 1/52

(52) U.S. Cl. 210/723

(57) ABSTRACT

A method of capturing and storing excess carbon dioxide (CO2) includes seeding melt water lakes formed on glacial masses with metal hydroxides. The excess CO2 is then stored as a precipitate from the seed of CO2 and metal hydroxides. Further, a method to apply nutrient minerals directly to pack-ice and open water promotes carbon sequestration by chlorophyll and subsequently phytoplankton, oxygen, and zooplankton.

### CROSS-REFERENCE TO RELATED APPLICATION

This application is related to and claims the benefit of Provisional Application Ser. No.: 61/164,624 filed Mar. 30, 2009, which is hereby incorporated by reference.

### FIELD OF THE INVENTION

The present invention generally relates to capturing and storing excess carbon dioxide (CO₂) and, more particularly details a method for capturing excess CO₂ by seeding melt water lakes formed on glacial masses with metal hydroxides. The excess CO₂ is then stored as a precipitate that can be utilized for further carbon sequestration in catalytic-ionic fertility for chlorophyll and subsequently phytoplankton, oxygen, zooplankton.

### BACKGROUND OF THE INVENTION

Its believed that the earth's climate is heating up at a faster rate than climate scientists were predicting as a direct result of increased greenhouse gas emissions. The runaway melting of polar glaciers was documented recently (Dockstader, N. (Producer). (2009, March). “Extreme Ice”. NOVA & National Geographic Television: PBS.). Research teams with time-lapse cameras recorded a much faster ice breakup rate than previously thought possible. More ice melting into the ocean results in an increase in oxygen entering the biosphere. Additionally, as the ice melts, CO₂ trapped in the ice is then released from the ice's open network matrix into the atmosphere.

The CO₂ that has absorbed over centuries into the glacial ice and remained encased there is now entering the ocean at increasing rates. Concurrently there is also increased photosynthesis, which takes carbon and other nutrients (in this case provided by the ice) to make chlorophyll, phytoplankton and O₂. Below the euphotic sunlight zone the ocean restoration benefits continue throughout the rest of the water column where ultimately, there is production of CO₂ via cellular respiration (Brassel S. C., et al. (2004) Recognition of alkenones in a lower Aptianporcellanite from the west-central Pacific. Organic Geochemistry, 35: 181-188.).

Brassel describes ocean photosynthesis as 6 parts CO2+6 H2O with sunlight to make C6H12O6+6 O2 (glucose and oxygen).

At the molecular level where light reactions take place, electron carriers must be present to lead to energy storage (mineral nucleation sites) by use of available magnesium, iron or calcium. Limited minerals present in frozen snow locked into the ice and are slowly released to the ocean. Snow has been called a poor man's fertilizer on land and the same is can be true on the ocean. Significant replenishment and restoration of the open ocean water is needed in selective locations. Unproductive areas low in nutrients exist beyond glacial activity are prevalent.

Precipitation may include some of the following dissolved parts of the air and particulate aerosols: N2, O2, Ar, CO2, Ne, He, SO2, H2S, and HCl volcano dust, Cl2, SO4, chlorides, and sulfates, suspended nitrates, sulfates, ammonium.

River runoff contributions are HCO3, Ca, SiO2, as well as Mg, potassium, nitrates, sodium, and phosphorus. The polar ocean regions happen to be out of the shipping lanes and away from terrain runoff. Large portions are unproductive nutrient-poor seas in the northern and southern latitudes.

Suggested here is to apply by wind, mechanical or water borne methods, measured seeding of nutrient mineral solutions, dusts, or solids which disperse over time as a function of the melting process involved with glaciers, pack-ice, and icebergs. If ice is not available, direct application to the wake of a ship is recommended to promote carbon sequestration by chlorophyll and subsequently phytoplankton, oxygen, and zooplankton.

Chalk contains an example of the ingredients of the Cretaceous ocean that behaved as a CO2 sink. Soft, friable chalk from that period has minute quantities of some minerals above and about half its weight is CaO (lime). Volcanic ash is another applicable source as well as diatomaceous earth. Other sources of nutrient availability are some areas of the ocean floor itself.

An object of the present invention is to use such materials for seeding purposes with assurance of the nutrient content naturally occurring or by addition, is needed to promote plant life common to the ocean water for a specific area of the ocean and in different phases to encourage algae blooms without detriment. More algae means more carbon dioxide is taken from the atmosphere and more oxygen released to the atmosphere.

Currently the atmospheric/ocean interface shows gas-absorption rates at equilibrium concentrations and the net exchange continues to be zero assuming no causes for deviation (Murray, 2001). Murray states that causes for deviation from equilibrium can be from non-conservative behavior such as photosynthesis (+), respiration (−) or de-nitrification (+). This is followed by bubbling or air injection, subsurface mixing and changes in atmospheric pressure. Although other situations do exist, if the ocean and atmosphere are in gaseous equilibrium “the transfer of gas continues [at the air/ocean interface] but the amount ‘pushed in’ just equals the amount ‘pushed out’” (Murray, J. (2001). Gases and gas exchange. Bothell, Wash.: University of Washington.).

In the case of melt water, the same can be true; especially in glacial lake water which has assumed lower pH values. This is due to increased atmospheric CO₂ released from the ice matrix and an approximately normal gas/water equilibrium steady state. It would therefore be highly beneficial to develop a method to capture and store this excess CO₂ to reduce greenhouse gas emissions.

A main objective of the present invention is to manipulate the increased rate of glacial melt process by capturing and sequestering the atmospheric CO₂ with controlled seeding of the melt waters with a metal hydroxide material either in powder form or water-based.

Subsequently another object of the present invention seeks to utilize other sources of alkalinity or concentration differences between cations and anions. These ions can be easily garnered from ash, clay or chalk material dissolutions, which are abundant sources for cations such as Ca2+, Fe3+, Mg2+, Na+and K+, and anions such as carbonate (CO32−), phosphate (PO43−), sulfate (SO43−) and silicate (SiO4−).

Other features and advantages of the present invention will be describing in or will be obvious from the detailed description that follows.

### SUMMARY OF THE INVENTION

In accordance with the present invention, the objects of the invention are achieved and the disadvantages of the greenhouse emissions caused by the melting of arctic glaciers and the like are eliminated or reduced by the two disclosed methods.

One of capture and storing excess CO₂ by seeding melt water lakes from glacial masses with metal hydroxide applied by wind, mechanical, or water borne techniques.

The second method is measured seeding of nutrient minerals by solution, dust, or solid dispersal as a function of the melting process involved with glaciers, pack-ice, and icebergs. If ice is not available, it is recommended nutrient minerals be applied to the wake of a ship to promote carbon sequestration by chlorophyll and subsequently phytoplankton.

### DETAILED DESCRIPTION OF THE INVENTION

To carry out one aspect of the present invention, one recommended metal hydroxide material is a calcium-based alkalinity added to the melt water, which is deprived of higher pH values on the surface of ice shelves. This would result in an overall uptake of CO₂ from the atmosphere. Carbon dioxide at the air/water interface reacts with calcium cations to form calcium carbonate precipitate which locks CO₂ into a seawater-insoluble (and safe) non-polluting solid. The equation, shown here, uses sodium (or potassium) hydroxide. Na₂CO₃ (or K₂CO₃)+Ca(OH)₂CaCO₃(s) (calcium carbonate precipitate)+2 NaOH (or KOH)

The disclosed application of alkaline material can be precisely measured and the results tracked using existing methods and data analysis. The additional oxygen ocean/atmospheric ultimately provided by the ice melt can also be tracked and measured as current technology continues to monitor algal and phytoplankton seasonal blooms.

Natural alkaline sources are recommended and include chalk deposits from the Cretaceous Period. These deposits are soft, friable, fine-grained, biogenic skeletal remains of seawater coccoliths and foraminiferas. These are located worldwide but they most notably dominate the scenery along the coastline of Dover in southern England. Midwestern United States, Europe, and India also each contain an abundance of chalk material formations.

Chalk is chemically composed of mostly non-compacted or non-solidified calcium carbonate (CaCO₃)—the precursor of limestone and marble—but about 56% of chalk is CaO (lime) and 44% CO₂. Lime in its natural state may be used without the normal high heat (1200° C.), four to five hour calciring process that is normally used in contemporary lime production. For example, the cement industry today takes broken-up, compacted, solid limestone rocks using high amounts of energy in high-heat cycles simply in order to bake out all of the CO₂ and end up with CaO.

Other alkaline sources ready-made by nature (no ‘baking’ required) include deposits of clay and volcanic ash. In North Dakota, for example, many volcanic ash beds—or tuffs—are known to be present where air fall events from 70 to 20 million years ago were gradually washed by wind and water and relocated to accumulate in large basins or stream beds (Murphy, Edward, Mineral resources of North Dakota: Volcanic Ash).

Another useful material for this purpose is diatomaceous earth: a widely deposited biogenic carbonate (calcareous plants) or silicate (radiolarian animals) in microscopic skeletal forms.

The overall method of the present invention includes seeding the glacial melt waters—from small lakes that appear on places such as Greenland's ice-shelf—to capture atmospheric carbon dioxide with alkaline deposits for the purpose of safely storing the CO₂ as a more environmentally-friendly carbonate or bicarbonate species.

The melt water lakes forming on the surfaces of the ice over a few weeks time, were only recently discovered by satellite images (Dockstader, N. (Producer). (2009, March). “Extreme Ice”. NOVA & National Geographic Television: PBS.) to first expand in size, and then suddenly disappear by drainage to the bottom of the glacier from weak points along the lake's floor region. The phenomenon is now more understood, and scientists also are now realizing that these draining melt waters serve to increase the rate of mass movement and lubricate the slide of the waters down the mile-thick shelf towards the sea.

Induced alkalinity of melt waters, even as they reach the bottom regions of moving glaciers, is predicted to continue the absorption of CO₂ inside the increasing friction/pressure zones. These zones are acting to release even more captured air bubbles containing old atmospheric air with its CO₂ content intact, forming additional carbonate and bicarbonate species.

The methods of the present invention can be applied in other places, such as tundra locations, which can be seeded in measured amounts in order to remediate the thawing permafrost release of additional CO₂ locked into the frozen biomass. It can also be applied to seeding—in measured amounts—disastrous weather events like monsoons and hurricanes to help rid air of excess anthropogenic CO₂.

Manipulating this melting process can result in sequestering of excess CO₂ and preventing it from entering the atmosphere. Mineral seeding becomes new sources for CO₂ capture by rafting alkaline-capturing calcium carbonate Ca(OH)2 to sequester atmospheric CO₂ on pack ice. Furthermore, as glaciers deteriorate, and as icebergs drift, they too may be treated by a measured seeding of aerated nutrient mineral solutions which disperse over time as a function of the melting process. The melt process then becomes a resource for additional production of atmospheric O2 by increasing the production of phytoplankton blooms. Currently, optimal growth of these blooms are inhibited ocean acidification caused by-among other things-dissolved CO₂.

For example, research in the Southern Ocean reported in an article entitled The Oceans Carbon Content by polar scientist Maria Vernet, “Icebergs release minerals and nutrients which promote phytoplankton blooms that maintain their position in surface waters.” But the plant cells, “at the end of summer sink several meters a day becoming food for benthic animals . . . Zooplankton swim up and down the water column, eating phytoplankton and producing fecal pellets which sink hundreds of meters a day, providing a very fast transfer of carbon to the ocean's depths” (Vernet, M. (2008, Jun. 22). The ocean's carbon content. Ice Stories: Dispatches From Polar Scientists, Retrieved April 20, 2009, from http://icestories.exploratorium.edu/dispatches/the-oceans-carbon-content/html.). This research suggests that more nutrient availability from the icebergs will promote more phytoplankton blooming in the polar seas where mineral deficiencies currently limit chlorophyll production.

The blooms are short-lived; eventually they join other sedimentation at the ocean bottom and leave the biosphere altogether. Stratified current, thermal gradient, convection, and up-welling are all considerations for their transport into and out of the euphotic zone and eventually to their demise. These tiny plants produce approximately half the earth's breathable oxygen via single-cell photosynthesis. They are food for crustaceans which “produce fecal pellet sedimentation sending the captured carbon safely to the ocean floor” (Vernet, 2008).

Currently there are companies that employ systems for converting CO₂ into calcium carbonate (CaCO3). CaCO3 is relatively inexpensive (approximately $1,000 per ton) and is found to be increasingly useful and beneficial for smart worldwide energy projects. Carbonate is a business that generates around $12 billion annually, and this number is continuing to grow. Derek McLeish, CEO of Carbon Sciences, predicts that their company will be able to deliver carbonates at 30 to 40% less than what current companies are paying now. Additionally, Carbon Sciences predicts that for every ton of carbonate around 440 kilograms of CO₂ will be captured (Kanellos, M. (2008, Jul. 17). Carbon capture: will the white powder win out? Greentech Media, Retrieved Apr. 20, 2009, from http://www.greentechmedia.com/articles/carbon-capture-will-white-power-win-out-1139.html<http://www.greentechmedia.com/articles/carbon-capture-will-white-power-win-out-1139.html>.).

The collected carbon dioxide can then be converted into baking soda, or sodium bicarbonate. One ton of CO₂ becomes 3.5 tons of carbonate. With sodium bicarbonate, you get a ratio of 1 ton of CO₂ to 1.9 tons of baking soda (Kanellos, M. (2008, Jul. 17). Carbon capture: will the white powder win out? Greentech Media, Retrieved Apr. 20, 2009, from http://www.greentechmedia.com/arliciestarbon-capture-wiH-white-power-win-out-1139.html<http://www.greentechmedia.com/articles/carbon-capture-will-white-power-win-out-1139.html>.).

Its apparent that ocean water favors magnesium calcite precipitation due to an abundance of skeletal remains-chalk-of cretaceous phytoplankton, species like pelagic surface dwelling coccolithophores and planktic foraminifers (protozoa). The calcification process is beneficial because it stimulates their growth and CO₂ consumption for photosynthetic processes. Carbonate or phosphate (PO43−) can be used to assist in this calcification process. “The carbon dioxide released during respiration reacts with water to produce carbonic acid and this assists the uptake of PO43− by plant roots” (Rhodes, C. (2009, Mar. 24). Plant nutrition. Weblog: Energy Balance. Retrieved Apr. 20, 2009, from http://ergobalance.blogspot.com/2009 03 01 archive.html.).

With iron, a recent study carried out a successful experiment known as the Lohafex project. The Southern Ocean is suffering from a decimating loss of plant life due to iron depletion from high levels of dissolved CO₂. In one day, scientists administered 10 tons of ferrous sulfate (FeSO4) to a 320 km2 area. Within days, ocean satellites picked up images of the resulting massive bloom of phytoplankton. The plant life made food available for tiny copepods, amphipods, and larger animals. The reported estimated weight of plant life created was already known and confirmed. “Each ton of iron yields the plant biomass equivalence of 367,000 tons of CO₂” (Martin, J. H., et al. (1994). Testing the iron hypothesis in ecosystems of the equatorial Pacific Ocean. Nature, 371: 123-129.).

However, other scientists have commented on the addition of iron or ferrous sulfate (FeSO4) by itself is not enough. For example, in an article in Science, Russell Seitz wrote “Many offshore areas sequester little carbon because their waters are perennially deficient in nitrogen and phosphorus as well” (Seitz, R. (2008, May 12). Carbon sequestration: should oceanographers pump iron? Science, 318, 1368-1370.).

What is claimed is:

1. A method of treating melt water lakes from masses of glacial or pack ice to capture and store excess CO₂, said method comprising the steps of:
a) identifying a target lake formed by the melting of ice;
b) providing a source of a metal hydroxide in a dispersible form;
c) disbursing said metal hydroxide onto the surface of said target lake to induce alkalinity therein;
d) reacting CO₂ at the air/water interface with cations of said metal hydroxide, thereby forming a precipitate which locks CO₂ into a seawater-insoluble, non-polluting composition.

2. The method of claim 1, wherein said metal hydroxide is calcium based whereby CO₂ at the air/water interface reacts with calcium cations to form a calcium carbonate precipitate.

3. The method of claim 1, wherein said metal hydroxide is dispersed in powder form.

4. The method of claim 1, wherein said metal hydroxide is dispersed in a water-based form.

5. The method of claim 1, wherein said metal hydroxide is sodium based whereby CO₂ reacts with sodium cations to form a sodium carbonate precipitate.

6. The method of claim 1, wherein said metal hydroxide is potassium based whereby CO₂ reacts with potassium cations to form a potassium carbonate precipitate.

7. The method of claim 1, including the steps of tracking the additional ocean/atmospheric oxygen ultimately provided by the ice melt, and monitoring algal and phytoplankton seasonal blooms.

8. The method of claim 1, wherein said metal hydroxide is from natural alkaline sources.

9. The method of claim 8, wherein said natural alkaline source comprises chalk deposits from the Cretaceous Period, said deposits being soft, friable, fine-grained, biogenic skeletal remains of seawater coccoliths and foraminiferas.

10. The method of claim 8, wherein said natural alkaline source comprises lime in its natural state.

11. The method of claim 8, wherein said natural alkaline source comprises volcanic ash.

12. The method of claim 8, wherein said natural alkaline source comprises diatomaceous earth selected from the group consisting of biogenic carbonate and biogenic silicate.

13. The method of claim 1, wherein said melt waters absorb CO₂ from glacier locations underneath said target lake location whereby captured air bubbles containing old atmospheric air are released to react to form additional precipitate.

14. A method of treating melt water from thawing permafrost to capture and store excess CO₂, locked into the frozen biomass, said method comprising the steps of:
a) identifying a target tundra location having thawing permafrost thereby to form water;
b) providing a source of a metal hydroxide in a dispersible form;
c) disbursing said metal hydroxide onto the surface of said target tundra location to induce alkalinity to said water;
d) reacting CO₂ at the air/water interface with cations of said metal hydroxide, thereby forming a precipitate which locks CO₂ into an insoluble, non-polluting composition.

15. The method of claim 14, wherein said metal hydroxide is calcium based whereby CO₂ at the air/water interface reacts with calcium cations to form a calcium carbonate precipitate.

16. The method of claim 14, wherein said metal hydroxide is dispersed in powder form.

17. The method of claim 14, wherein said metal hydroxide is dispersed in a water-based form.

18. The method of claim 14, wherein said metal hydroxide is sodium based whereby CO₂ reacts with sodium cations to form a sodium carbonate precipitate.

19. The method of claim 14, wherein said metal hydroxide is potassium based whereby CO₂ reacts with potassium cations to form a potassium carbonate precipitate.

20. A method of sequestering excess CO₂ from melting pack ice, said method comprising: applying Ca(OH)₂ to the water formed by said melting pack ice to thereby sequester atmosphere CO₂.

21. The method of claim 20, including the step of treating said melting ice with an aerated nutrient mineral solution to thereby provide a source for the increased production of phytoplankton bloom and atmospheric O₂ therefrom.

22. The invention of claim 21, wherein said nutrient mineral solution comprises Cretaceous chalk dust with sufficient amounts of carbon, nitrogen, oxygen, magnesium, iron, calcium, phosphate, potassium, ammonium, nitrate, sulfate, silicon dioxide to be added, if necessary, depending on the ocean area content and requirements.

23. The invention of claim 21, wherein said nutrient mineral solution comprises of diatomaceous earth with sufficient amounts of carbon, nitrogen, oxygen, magnesium, iron, calcium, phosphate, potassium, ammonium, nitrate, sulfate, silicon dioxide added, if necessary, depending on the ocean area content and requirements.

24. The invention of claim 21, wherein said nutrient mineral solution comprises volcanic ash with sufficient amounts of carbon, nitrogen, oxygen, magnesium, iron, calcium, phosphate, potassium, ammonium, nitrate, sulfate, silicon dioxide added, if necessary, depending on the ocean area content and requirements.

25. The invention of claim 21, wherein said nutrient mineral solution comprises of combinations of chalk, diatomaceous earth, and volcanic ash with sufficient amounts carbon, nitrogen, oxygen, magnesium, iron, calcium, phosphate, potassium, ammonium, nitrate, sulfate, silicon dioxide added, if necessary, depending on the ocean area content and requirements.

26. The invention of claim 21, wherein said nutrient mineral solution comprises of limited sea floor extraction to supply nutrients at surfaces in ocean locations where desert conditions exist to provide sediments rich in calcareous and siliceous oozes to promote further plant growth where sediments and dynamics of the water column are clearly understood.

27. The invention of claim 21, wherein said nutrient mineral solution includes carbon, nitrogen; oxygen, magnesium, iron, calcium, phosphate, potassium, ammonium, nitrate, sulfate, and silicon dioxide.
